(19) United States
(12) Patent Application Publication
(10) Pub. No.: US 2012/0039219 A1
(43) Pub. Date: Feb. 16, 2012

(54) HIGHLY SCALABLE VOICE CONFERENCING SERVICE

(75) Inventor: Dean Elwood, London (GB)

(73) Assignee: BLABBELON, INC., New York, NY (US)

(21) Appl. No.: 13/206,650

(22) Filed: Aug. 10, 2011

Related U.S. Application Data
(60) Provisional application No. 61/372,134, filed on Aug. 10, 2010.

(51) Int. Cl. H04L 12/16

(52) U.S. Cl. 370/260

(57) ABSTRACT

A high volume voice conferencing system serving a plurality of users. The system determines whether incoming packets from the plurality of users contains voice information or noise. Packets containing noise are dropped from the system and only voice packets are processed as part of the voice conferencing arrangement.

Dropping the unnecessary noise packets increases the capacity of the voice conferencing system.

### PRIORITY AND RELATED APPLICATIONS

This application claims priority to U.S. Provisional Patent Application Ser. No. 61/372,134 filed Aug. 10, 2010 entitled “HIGHLY SCALABLE VOICE CONFERENCING SERVICE” which is hereby incorporated by reference in its entirety.

### FIELD OF THE INVENTION

The present invention relates to communication systems, particularly to a voice conference system.

### BACKGROUND OF THE INVENTION

The leading problem within the conferencing service industry is scalability. Scaling refers to the number of simultaneous conference users manageable by a single server, and the power consumed by the server per user. Voice conferencing services, in digital form, can typically handle around 200 simultaneously connected client devices (either telephones or a software client) per server. The term “conferencing system” is applicable to both gaming use and general telephony use. The majority of modern conferencing systems are software based running on standard Intel hardware servers occupying on average 1U of rack space and consuming around 80 watts of electrical power.

Scalability is a typical and well-known limitation present in the gaming services and in the telephony industry. Some advances in efficiency have been made in the telephony industry, but scaling still remains ultimately the limiting factor. For example, FreeSwitch, a popular softswitch, can handle up to nearly 300 simultaneous conference callers. Also, ConferenceGenie, a popular UK business based telephone conference system currently operates 7 conference servers enabling it to manage conference calls for around 1500 simultaneous users.

Referring to FIG. 1, an example of a typical conference system of the prior art is shown. Such system may use a standard Intel server device running a conferencing software application. The software application contains several components such as an authentication system (not shown), an inbound audio routing system (Audio In at 1) capable of receiving digital audio streams from multiple connected client devices (Client n-Client n+2), a Digital Signal Processor (DSP at 2) capable of combining all received digital audio streams into a single audio stream and a Mixed Audio Distributor (MAD at 3) which relays the mixed single audio streams back to connected clients. The client devices n-n+2 used in FIG. 1 are shown to be telephones.

In terms of scaling, the biggest consumer of server power and resource is the DSP. The DSP requires intensive floating point arithmetic in order to take multiple audio streams in a digital form and “combine” or “blend” them into a single audio stream ready to send to the MAD generating heat and saturating the servers overall capacity. Ultimately, this is what creates the limiting factor in volume of users that a server can handle simultaneously.

Voice detection methods are known in the art and are used to distinguish voice from noise. For example, voice operated switches (frequently referred to as “VOX”) exist in the communication field and, in one embodiment, are directed to controlling communication based on the level of audio strength in a given packet. For example, using an 8 bit audio codec, silence would be represented with a value of zero and maximum volume (a high intensity packet potentially being voice) would have a value of 256. Such algorithms look for mean averages of a packet to detect human voice. Further refinements have been made in this field by looking for the frequencies of audio present in a packet, and specifically examining for frequencies which typically occur in human voice, but this design requires a DSP and therefore does not avoid the scaling and floating point arithmetic problems.

A noticeable failure in the communications and conferencing systems of the prior art is the obvious disregard to the natural manner in which people communicate. Generally, in a group context only one person speaks at any given moment. As a result, if only one person is speaking, the DSP is not performing a useful function because it would only be mixing silence with the talking user's audio. In typical conference situations, if two or more people start speaking simultaneously one will then stop and let the other continue. The instances of simultaneous voice streams (talkers) being received by the conference server are actually therefore low relative to the number of users on the conference (listeners).

A conferencing system is desired that understands how people communicate in a group or conference setting. A conferencing system is desired that overcomes limitations of 200-300 users per single server and can serve several thousand customers per single server. A conferencing system is further desired that will run at a lower cost base and will reduce the server cost.

### BRIEF DESCRIPTION OF THE DRAWINGS

FIG. 1 shows a conference system of the prior art.

FIG. 2 shows a conference system of the present invention.

FIG. 3 shows a Multi-Party Chat System of the present invention.

### BRIEF DESCRIPTION OF THE INVENTION

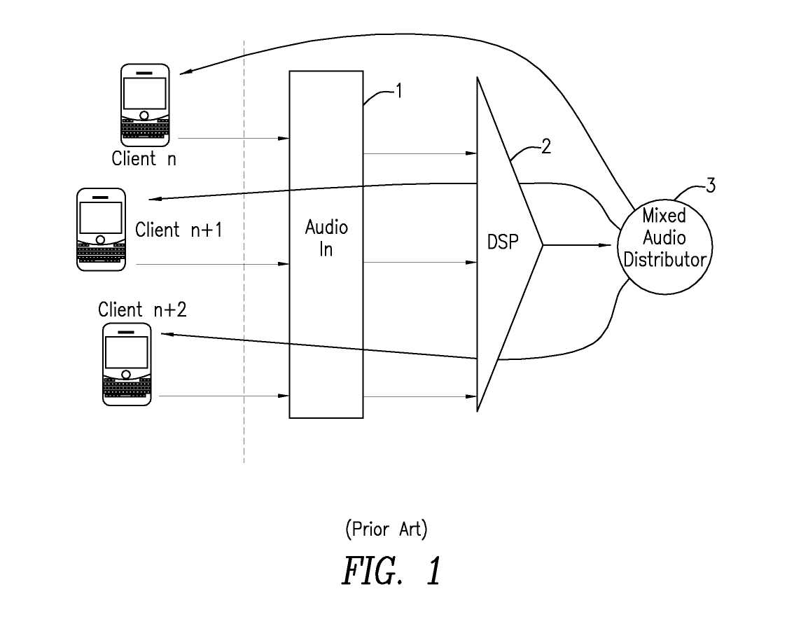

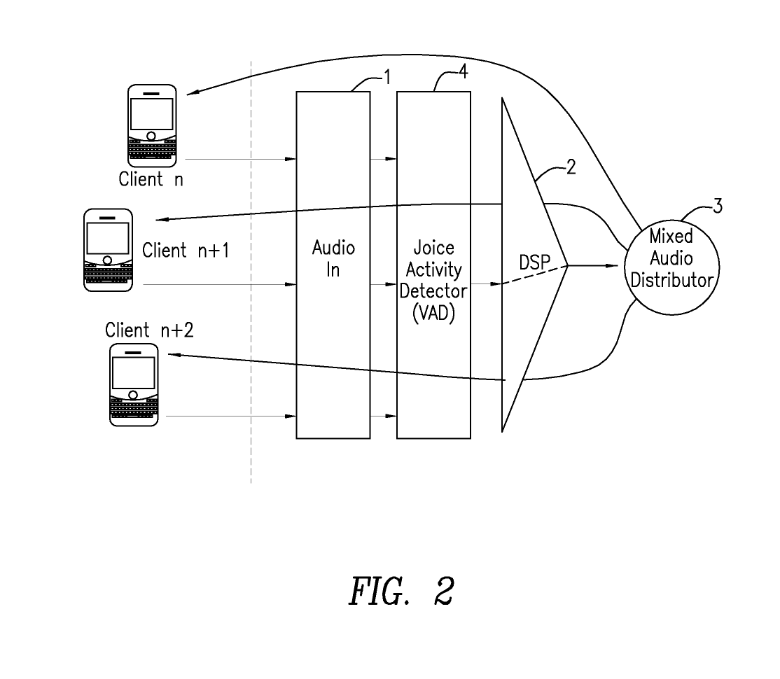

FIG. 2 depicts one embodiment of a conferencing system of the present invention. The system shown in FIG. 2 provides a Voice Activity Detector unit (VAD at 4) not used in the prior art systems of FIG. 1. The VAD monitors incoming audio streams from each connected user and algorithmically detects whether an incoming audio packet contains human voice or only noise.

Various algorithms exist for detecting whether incoming packets contain voice or noise. See for example;

### Cohen I. (Sept. 2003) “ Noise Spectrum Estimation in Adverse Environments: Improved Minima Controlled Recursive Averaging”. IEE Transactions on Speech and Audio Processing (5): pp. 466-475.

### ETSI (1999). “Digital Cellular Telecommunications System (Phase 2+); Half Rate Speech; Voice Activity Detector (VAD) For Half Rate Speech Traffic Channels (GSM 06.42). 8.0.1. ETSI.

Freeman, D. K. (May 1989) “The Voice Activity Detector for the Pan-European Digital Cellular Mobile Telephone Service”. Proc. International Conference on Accoustics, Speech and Signal Processing (ICASSP-89). pp. 369-372, and
Ramirez et al. (2004) “Efficient Voice Activity Detection Algorithms Using Long-Term Speech Information”. (www.sciencedirect.com).

Any suitable voice detection algorithm can be used by the present invention, including the VAD's available in the SILK and GIPS audio libraries which are respectively provided by Skype, Inc. and Google, Inc.

If a given packet is deemed by the VAD to contain human voice, it is sent to the Digital Signal Processor (“DSP”) for mixing. If it is not, the packet is dropped and therefore avoids being processed by the DSP. Such algorithms are extremely efficient in terms of CPU and server resource usage since they can be concerned only with integer arithmetic as opposed to the floating point arithmetic required by a DSP. The algorithm may be a progressive sampling of packets by the VAD—looking at the current packet of audio and a varying number of packets just prior to it, and examining the power levels within each one to apply a weighting in order to look for a typical fingerprint of voice.

The introduction of the VAD system allows the selective routing (“selective mixing”) of only voice traffic into the DSP and thereby reducing the DSP overhead when performing its mixing function. There is still a DSP overhead when multiple people are talking; the improvement is that the DSP does not need to be functioning all the time—if only one person is speaking, the VAD does not ask the DSP to perform any mixing function. Such a design can be expressed as “selective mixing” whereby only certain streams are mixed, based on whether or not they contain anything “worth” mixing.

Thus, the system shown in FIG. 2 uses the VAD to exponentially reduce the burden normally placed on the DSP. Specifically, the VAD ensures that the DSP is engaged when multiple people are speaking simultaneously and disengaged when only one person is speaking. The VAD system was tested with the design shown in FIG. 2 by operating with 10,000 simultaneously connected users on a single 1U server consuming around 80 watts of power.

There are other alternative means to perform “selective mixing” other than peak audio detection and a requirement that a packet contain voice. Thus, in an alternative embodiment to that shown in FIG. 2, the VAD could be replaced by a ranking circuit which would determine which packets are applied the the DSP based on rank, wherein connected clients are ranked and depending on the order of the rank wherein only certain ranks are allowed to speak if someone else is already speaking This embodiment addresses instances where several people are speaking at the same time, which in practice is usually momentary and temporary.

For example, using a gaming scenario, usually one person (administrator) or collection of people (moderators) “owns” a conference room. The owner of the conference room has priority over other users such that if the owner wishes to speak, everyone else in the conference is silenced. In the same manner, multiple ranks could be assigned to connected clients whereby only clients of a certain rank could ever be allowed through to the DSP in the event that other people are talking Or, stated otherwise, only certain ranks of user could “talk over” an existing talker.

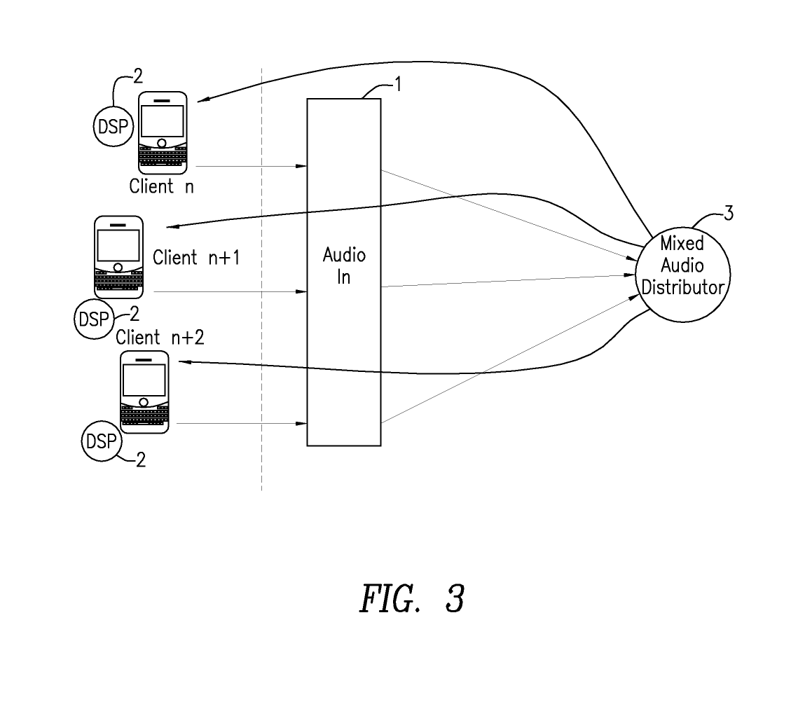

FIG. 3 shows another embodiment of the present invention. FIG. 3 shows a system wherein the DSP is removed entirely from the server and placed within the client device, the telephone. In this embodiment, all audio streams are received by the conference server and are immediately routed back to all connected client devices, without processing by a DSP or a VAD. All “effort” in terms of CPU overhead is thereby transferred to the connected client's device such as a telephone or personal computer.

In this embodiment, all users of this embodiment would require a DSP in the client device they use. To attain this embodiment, using a computer a user would download a software application through a web browser using a JAVA based “applet” and install the software on the client device. Thus, using this embodiment, all server overhead other than the distribution of packets, is removed. This embodiment may well be useful in the gaming market where such services are typically used from software applications that the user downloads.

As an extension of the embodiment shown in FIG. 3, another embodiment may be realized where both the DSP and a VAD system reside on the client device rather than the server. Such an embodiment provides additional performance benefits in voice conferencing systems. In this embodiment, the client device would not necessarily mix all audio, it would only mix audio which was deemed to be voice (as opposed to background noise). Accordingly, the DSP mixing at the client side itself would be more efficient.

While the present invention has been described in conjunction with specific embodiments, those of normal skill in the art will appreciate the modifications and variations can be made without departing from the scope and the spirit of the present invention. Such modifications and variations are envisioned to be within the scope of the appended claims.

What is claimed:

1. A voice conferencing system, comprising:
a plurality of user input devices for introducing digital packets into the voice conferencing system with some, but not all, of the digital packets containing voice information,
an audio routing device for receiving the incoming digital packets from the plurality of user input devices,
a voice activity detector for receiving the incoming digital packets from the audio routing device, detecting which incoming packets contain voice information and discarding incoming digital packets which do not contain voice information,
a digital signal processor for receiving the incoming digital packets containing voice information from the voice activity detector and for combining the packets containing voice information into a single stream of voice information packets, and
a mixed audio distributor for receiving the voice information packets from the digital signal processor and returning the voice information packets to the plurality of user input devices.

2. The system of claim 1, wherein said voice activity detector employs an algorithm, said algorithm being used to identify voice information in a digital packet.

3. The system of claim 1, wherein said voice activity detector employs a ranking system to determine the order of routing voice traffic into said digital signal processor.

4. The system of claim 1, wherein said voice activity detector only routes voice information packets into the digital signal processor.

5. The system of claim 1, wherein said digital signal processor is disposed in a user device.

6. The system of claim 1, wherein said digital signal processor and said voice activity detector are disposed in a user device.

7. A method to improve the performance of a voice conferencing system, comprising:
Inputting digital packets from a plurality of user input devices into the voice conferencing system, with some, but not all, of the digital packets containing voice information,
detecting which digital patents contain voice information and discarding all incoming digital packets which do not contain voice information,
combining the digital packets containing voice information from the plurality of user input devices into a single stream of voice information packets, and
returning the voice information packets to the plurality of user input devices.

8. The method of claim 7, wherein said detecting step utilizes an algorithm, said algorithm being used to identify the voice information packets.

9. The method of claim 7, wherein said detecting step ensures that combining step is performed when multiple users are speaking simultaneously and disengaged when only one user is speaking.

10. The method of claim 7, wherein said defecting step and said combing step are performed in a user device.
